(19) United States
(12) Patent Application Publication
(10) Pub. No.: US 2025/0320895 A1
(43) Pub. Date: Oct. 16, 2025

(54) MAGNETIC LEVITATION DEVICE AND AN ELECTROMAGNETIC ROTARY DRIVE

(71) Applicant: Levitronix GmbH, Zürich (CH)

(72) Inventor: Daniel Steinert, Bülach (CH)

(21) Appl. No.: 19/090,859

(22) Filed: Mar. 26, 2025

(30) Foreign Application Priority Data
Apr. 16, 2024 (EP) 24170637.3

(51) Int. Cl. F16C 32/04; H02K 7/09

(52) U.S. Cl. CPC F16C 32/0474; H02K 7/09

(57) ABSTRACT

A magnetic levitation device includes a stator including coil cores, each coil core having a longitudinal leg extending from a first end in an axial direction to a second end, and a transverse leg arranged at the second end of the longitudinal leg, and extending in a radial direction. A back iron is arranged at the first end of the coil cords and connects the first ends of the longitudinal legs. A concentrated winding is provided on each longitudinal leg, and surrounds the longitudinal leg. The stator has a cup-shaped recess into which the rotor is capable of being inserted, the cup-shaped recess arranged at an axial end of the stator, and a shielding extending in the circumferential direction along the coil cores. The shielding extends in the axial direction from a first shielding end to a second shielding end.

### CROSS REFERENCE TO RELATED APPLICATIONS

This application claims priority to European Application EP 24170637.3, filed Apr. 16, 2024, the contents of which are hereby incorporated by reference.

### BACKGROUND

### Technical Field

The disclosure relates to a magnetic levitation device and to an electromagnetic rotary drive with such a magnetic levitation device.

### Background Information

Magnetic bearing devices for contactless magnetic bearing of a rotor have the advantage that they do not require mechanical bearings for the rotor. The rotor is supported or stabilized by magnetic forces which are generated by a stator of the magnetic bearing device. Due to the absence of mechanical bearings, such magnetic bearing devices are in particular suitable for pumping, mixing, centrifuging or stirring devices, with which very sensitive substances are conveyed, for example blood pumps, or on which very high demands are made with respect to purity, for example in the pharmaceutical industry or in the biotechnological industry, or with which abrasive or aggressive substances are conveyed, which would very quickly destroy mechanical bearings, for example pumps or mixers for slurry, sulfuric acid, phosphoric acid or other chemicals in the semiconductor industry.

In the biotechnology industry, such magnetic bearing devices are used, for example, in connection with bioreactors, e.g. in centrifugal pumps for conveying the fluids into or out of the bioreactor, or in mixing devices which mix the fluids in the bioreactor. In the semiconductor industry, such magnetic bearing devices are not only used for conveying aggressive or abrasive substances, but also, for example, for rotation devices with which wafers are rotated.

### SUMMARY

It is also known to use magnetic bearing devices for viscometers.

It has been determined that an advantageous and design known per se of a magnetic bearing device is the design in temple construction, to which the present disclosure also relates.

The characteristic feature of the temple construction is that the stator of the magnetic bearing device has a plurality of coil cores, each of which comprises a longitudinal leg extending from a first end in an axial direction to a second end. Here, the axial direction refers to that direction which is defined by the desired axis of rotation of the rotor, which is supported by the magnetic bearing device. The desired axis of rotation is that axis of rotation about which the rotor rotates in the operating state when it is in a centered and non-tilted position with respect to the stator. Each coil core comprises, in addition to the longitudinal leg, a transverse leg, which is arranged in each case at the second end of the longitudinal leg, and which extends in the radial direction-usually towards inside, wherein the radial direction is perpendicular to the axial direction. Thus, the transverse leg extends substantially at a right angle to the longitudinal leg. The coil cores each have the shape of an L, wherein the transverse legs form the short legs of the L. The rotor to be supported is then arranged between the transverse legs.

The plurality of the longitudinal legs which extend in the axial direction, and which are reminiscent of the columns of a temple has given this construction its name.

In one design, the stator of the magnetic bearing device has, for example, six coil cores which are arranged circularly and equidistantly around a cup-shaped recess into which the rotor can be inserted. The first ends of the longitudinal legs are usually connected in the circumferential direction by a back iron, which serves to conduct the magnetic flux. The rotor to be supported comprises a magnetically effective core, for example a permanent magnetic disk or a permanent magnetic ring, which is arranged between the radially inside located ends of the transverse legs, and which rotates about the axial direction in the operating state, wherein the rotor is magnetically supported without contact with respect to the stator.

For such magnetic bearing devices, it is not necessarily the case that the magnetically effective core of the rotor must be designed in a permanent magnetic manner. There are also known such designs in which the magnetically effective core of the rotor is designed in a permanent magnetic-free manner, i.e., without permanent magnets. Then, the magnetically effective core of the rotor is, for example, designed in a ferromagnetic manner and is made, for example, of iron, nickel-iron, cobalt-iron, silicon iron, mu-metal, or another ferromagnetic material.

Furthermore, designs are possible in which the magnetically effective core of the rotor comprises both ferromagnetic materials and permanent magnetic materials. For example, permanent magnets can be placed or inserted into a ferromagnetic base body. Such designs are advantageous, for example, if one wishes to reduce the costs of large rotors by saving permanent magnetic material.

The longitudinal legs carry windings to generate the electromagnetic fields necessary for the contactless magnetic bearing of the rotor. For example, the windings are designed such that one concentrated winding is wound around each longitudinal leg, i.e., the coil axis of each concentrated winding extends in each case in the axial direction. Here, it is typical for the temple construction that the coil axes of the concentrated windings run in the axial direction and that the concentrated windings are not arranged in the radial plane in which the rotor or the magnetically effective core of the rotor is supported in the operating state.

Designs are possible in which exactly one concentrated winding is arranged on each longitudinal leg. In other designs, several, for example exactly two, concentrated windings are provided on each longitudinal leg. Designs are also possible in which windings are provided that are wound around two longitudinal legs that are adjacent in the circumferential direction, so that these two adjacent longitudinal legs are both located in the interior space of the concentrated winding.

The stators of the magnetic bearing devices are encapsulated in stator housings so that they can withstand the demanding conditions of the aforementioned fields of application. The stator housings known from the state of the art are mostly made of aluminum to ensure a good heat dissipation from the windings, for example. Housings are known that comprise cooling fins to improve the heat dissipation in this way. It is also known to protect the housings more robustly with coatings against external influences such as aggressive chemicals.

The use of aluminum as a stator housing is ideal due to its good heat conductivity in order to achieve a good heat dissipation from the stator. However, the use of aluminum also has disadvantages. The aluminum housing is not only good heat-conducting but is also electrically good conductive. This results in the generation of eddy currents in the stator housing. The windings of the stator not only generate magnetic fields inside the stator, i.e. towards the center axis of the stator for the bearing and the drive of the rotor, but magnetic fields that run outside the stator are also generated. These magnetic fields penetrate the good conductive aluminum housing. During operation of the magnetic bearing device, eddy currents are then generated in the housing, which cause significant losses and generate heat in the housing, whereby the motor is also heated inside.

Starting from this state of the art, it is therefore an object of the disclosure to propose a magnetic levitation device for contactless magnetic levitation of a rotor with a disk-shaped or ring-shaped magnetically effective core, which has lower eddy current losses than the previous state of the art and at the same time ensures an effective heat dissipation.

Furthermore, it is an object of the disclosure to propose an electromagnetic rotary drive with such a magnetic levitation device.

The subject matter of the disclosure meeting this object is characterized by the features of the independent patent claim.

According to the disclosure, a magnetic levitation device is thus proposed for contactless magnetic levitation of a rotor, which comprises a disk-shaped or ring-shaped magnetically effective core, wherein the magnetic levitation device has a stator with a stator housing, which stator comprises a plurality of coil cores, each of which comprises a longitudinal leg, which extends from a first end in an axial direction to a second end, as well as a transverse leg, which is arranged at the second end of the longitudinal leg, and which extends in a radial direction, which is perpendicular to the axial direction, wherein a back iron is arranged at the first end, which connects the first ends of all longitudinal legs, wherein at least one concentrated winding is provided on each longitudinal leg, which surrounds the respective longitudinal leg, wherein the stator further has a cup-shaped recess into which the rotor can be inserted, wherein the cup-shaped recess is arranged at an axial end of the stator, and wherein the transverse legs are arranged around the cup-shaped recess. The stator comprises a shielding which extends in the circumferential direction along a plurality of coil cores, wherein the shielding extends in the axial direction from a first shielding end to a second shielding end.

By using a shielding, magnetic fields can be prevented from escpaing from the stator to the outside, i.e. out of the stator housing. The magnetic fields no longer penetrate the stator housing, but are conducted inside the stator housing, which leads to a reduction in eddy current losses.

A further advantage of using a shielding in the interior of the stator housing is that the stator housing can still be made of an electrically good conductive material, such as aluminum. As a result, the dissipation of the heat generated during operation of the stator functions reliably.

The shielding extends radially outwardly in the circumferential direction along a plurality of coil cores. The shielding can be open in the circumferential direction, i.e. the shielding only extends along a plurality of coil cores, or closed, i.e. the shielding extends along all coil cores. Embodiments are also possible in which notches are provided in the shielding. These notches can be provided, for example, for the feedthrough of connectors through the shielding, such as cables.

According to a preferred embodiment, the shielding is arranged radially outwardly around the coil cores and extends in the circumferential direction over an angle of at least 120 degrees, preferably at least 240 degrees.

According to a preferred embodiment, the shielding is designed in a ring-shaped manner.

Due to the construction of the stator, it is advantageous to use a ring-shaped designed shielding. However, it is also possible that the shielding is designed in a polygonal manner, e.g. hexagonal or octagonal. The design of the shielding can be individually adapted to the shape of the corresponding stator or the corresponding coil cores and/or their arrangement.

In a preferred embodiment, the shielding comprises at least two shielding segments, each of which extends from a first segment end in the circumferential direction to a second segment end.

Furthermore, it is preferred that the shielding segments are arranged adjacent to each other in the circumferential direction. Embodiments are also possible in which the shielding segments are arranged adjacent to each other in the axial direction.

In this context, arranged adjacent to each other comprises that there is a distance between the shielding segments as well as that they are in butt contact as well as that they overlap.

According to another preferred embodiment, the shielding is designed as a strip, wherein the strip forms several strip windings which lie flat against one another with respect to the radial direction and are particularly preferably insulated from one another.

Here, the strip can be made of an electrical sheet metal, preferably a grain-oriented electrical sheet metal. According to the general definition, an electrical sheet metal is understood to be a soft magnetic material for magnetic cores. There also exists the possibility of using mu-metal as the material for the strip.

Here, the advantage is that such strips are frequently used in technology and are therefore cost-effective. It is also advantageous that a strip can be produced relatively easily and that it is possible that the strip windings can be insulated from one another directly during production.

Furthermore, according to another preferred embodiment it is preferred that the first shielding end is arranged with respect to the axial direction at the same height as a first winding end.

In the case that exactly one winding is arranged at the longitudinal leg, the first winding end refers to the end of this winding which is located closer to the first end of the longitudinal leg in the axial direction. The first winding end can also be regarded as the axially lower winding end if the second winding end is arranged closer to the second end of the longitudinal leg with respect to the axial direction and thus represents an axially upper winding end. In the case that more than one winding is arranged at the longitudinal leg, the first winding end is the first winding end of that winding which is arranged closer to the first end of the longitudinal leg in the axial direction. In other words, the first winding end is the axially lower end of the axially lowermost winding arranged at the longitudinal leg. Here again, the definition applies that “lower” means closer to the first end of the longitudinal leg and “upper” means closer to the second end of the longitudinal leg.

The arrangement of the first shielding end with respect to the axial direction at the same height as the first winding end is advantageous, as the windings are mainly responsible for stray fields because the magnetic fields are generated there. Thus, the shielding ensures an effective shielding of the magnetic fields at the location where they are generated and thus prevents them from penetrating the stator housing.

Of course, it is also possible that the first shielding end is arranged below the first winding end in the axial direction. This can be advantageous for reasons of stability, for example.

In another preferred embodiment, the first shielding end is arranged with respect to the axial direction above the first winding end.

The stray fields are particularly strong especially in the upper area of the stator, i.e. in the area that is closer to the second end of the longitudinal leg in the axial direction. The reason for this is that the iron circuit is not closed there, and the magnetically effective core of the rotor thus only conducts its own magnetic field but not that of the windings. On the other hand, in the lower area of the stator, i.e. in the area that is located closer to the first end of the longitudinal leg in the axial direction, the magnetic fields are well conducted by a back iron and there are significantly fewer stray fields. Thus, it is advantageous to arrange the shielding in the upper area of the stator. A smaller extension of the shielding in the axial direction also has the advantage that there is the possibility to build the stator more compactly, which means that less material is required, resulting in lower costs.

According to a preferred embodiment, the shielding extends with respect to the axial direction to a housing cover of the stator, wherein the housing cover is arranged at a first end of the stator.

Here, different designs of the housing cover are possible and, depending on its design, the shielding can extend to the housing cover so that a contact between the two is possible. In the case that the housing cover is made of plastic, the shielding can be in contact with the housing cover, as the plastic housing cover is not conductive. In the case that the housing cover is made of electrically conductive material, there should be a distance between the shielding and the housing cover, as otherwise the effect of reducing eddy current losses could be reduced. It is also possible that the shielding has a thin area at its second shielding end over its entire extension in the circumferential direction, which extends in the axial direction, and which is made of an electrically non-conductive material. It is also possible to achieve such an insulating layer by coating the shielding at the second shielding end.

A maximum possible extension of the shielding to the housing cover is advantageous because, as already described, most stray fields occur at the axially upper end of the stator.

Furthermore, it is preferred to make the shielding of a highly permeable material, preferably of a highly permeable material comprising iron and silicon.

In the framework of this application, a highly permeable material is understood to be a material that has a relative permeability μ>40. Further properties of such a material are, inter alia, that it has a low electrical conductivity and low hysteresis losses.

According to a preferred embodiment, the shielding is designed as a coating, which is preferably applied to a radially inside located side of the stator housing. The coating has the advantage that it can be applied to the already existing stator housing by the usual coating methods known from the state of the art (e.g. PVD method, thermal spraying). In doing so, no additional material (such as electrical sheet metal) is required for the shielding and the shielding can already be applied during the production of the stator housing, which saves an additional work step. Preferably, the coating comprises iron and/or plastic-bonded metal particles. Preferably, the coating thickness is greater than 50 micrometers.

According to a preferred embodiment, the shielding is designed as a sheet metal. Here, the sheet metal can contain iron and/or silicon. There also exists the possibility of using a mu-metal sheet and/or an electrical sheet metal, preferably a grain-oriented electrical sheet metal. It is possible that the sheet metal is bent into a ring shape and can thus be adapted to fit the outer shape of the coil cores and the stator housing precisely.

Furthermore, it is preferred that each coil core is made of elements in sheet metal, wherein the elements are stacked in the circumferential direction of the stator.

This means that several sheet metals in the form of the coil cores are stacked insulated from one another in the circumferential direction. The sheet metal design of the coil cores prevents eddy currents for magnetic fields that run in the direction of the sheet metals, i.e. fields that follow the longitudinal leg in the axial direction and the transverse leg in the radial direction. Here again, electrical sheet metal or mu-metal sheet can be used as preferred materials.

According to a further preferred embodiment, two concentrated windings are provided on each longitudinal leg, each of which surrounds the respective longitudinal leg, and which are arranged adjacent to each other with respect to the axial direction.

According to a further preferred embodiment, the shielding comprises at least two shielding parts, which are arranged adjacent to each other in the axial direction. This means that the at least two shielding parts can be stacked with respect to the axial direction. Here it is possible that the individual shielding parts are made of different materials. It is also possible that the individual shielding parts are designed differently with regard to their shape.

Furthermore, it is preferred that the coil core has a rounding off at an axially upper end, which redirects the coil core from the axial direction to the radial direction.

Furthermore, an electromagnetic rotary drive which is designed as a temple motor is proposed by the disclosure, wherein the electromagnetic rotary drive comprises a magnetic levitation device according to the disclosure as well as a rotor with a disk-shaped or ring-shaped magnetically effective core, wherein the rotor can be inserted into the cup-shaped recess, and wherein the rotor is designed as the rotor of the electromagnetic rotary drive.

Such electromagnetic rotary drives are also known as bearingless motors. The term bearingless motor refers to an electromagnetic rotary drive in which the rotor is completely magnetically levitated with respect to the stator, wherein no separate magnetic bearings are provided.

Further advantageous measures and embodiments of the disclosure are apparent from the present disclosure.

### BRIEF DESCRIPTION OF THE DRAWINGS

In the following, the disclosure will be explained in more detail with reference to embodiments and with reference to the drawing. In the drawing show:

FIG. 1 is a perspective view of a first embodiment of a magnetic levitation device according to the disclosure, wherein a part of the stator housing is removed,

FIG. 2 is a sectional view of the first embodiment of a magnetic levitation device from FIG. 1,

FIG. 3 is a sectional view of a second embodiment of a magnetic levitation device according to the disclosure,

FIG. 4 is a sectional view of a third embodiment of a magnetic levitation device according to the disclosure,

FIG. 5 is a sectional view of a fourth embodiment of a magnetic levitation device according to the disclosure,

FIG. 6 is a perspective view of a fifth embodiment of a magnetic levitation device according to the disclosure, wherein a part of the stator housing is removed, and

FIG. 7 is a sectional view of a sixth embodiment of a magnetic levitation device according to the disclosure.

### DETAILED DESCRIPTION

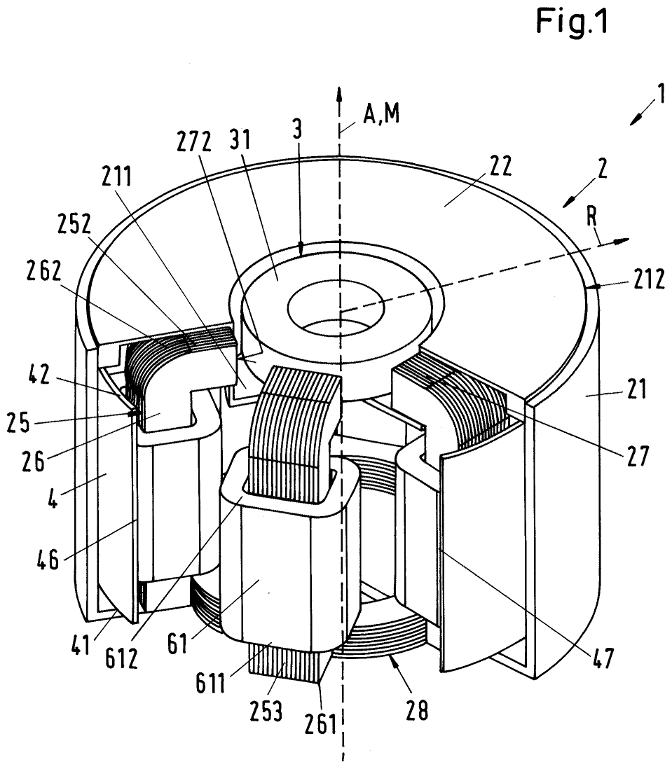

FIG. 1 shows a perspective view of a first embodiment of a magnetic levitation device according to the disclosure, which is designated in its entirety by the reference sign 1. The magnetic levitation device 1 is designed for the contactless magnetic levitation of a rotor 3, which comprises a disk-shaped or ring-shaped magnetically effective core 31. The magnetic levitation device 1 is designed according to the temple construction and comprises a stator 2. The stator 2 comprises a stator housing 21, wherein in FIG. 1 a part of the stator housing 21 is removed for a better overview, wherein a housing cover 212 is arranged at a first end of the stator 22, which is connected to the stator housing 21 and sealed so that no undesired substances can penetrate into the interior of the stator housing 21.

The stator housing 21 is usually made of metal, preferably aluminum, the housing cover 212 is in this case made of a plastic, preferably polypropylene. The connection of the stator housing 21 and the housing cover 212 is preferably made by welding or gluing. However, it is also possible to make the stator housing 21 and the housing cover 212 from the same material. For example, stainless steel can also be used as the material for the stator housing 21 and the housing cover 212.

A cup-shaped recess 211 is provided in the housing cover 212 into which the rotor 3 can be inserted. The rotor 3 is designed for rotation about a desired axis of rotation. This desired axis of rotation defines an axial direction A. Normally, the center axis of the stator 2, which extends in the axial direction A, coincides with the desired axis of rotation. The desired axis of rotation designates that axis about which the rotor 3 rotates in the operating state when the rotor 3 is in a centered and non-tilted position with respect to the stator 2, as represented in FIG. 1.

The stator 2 has a plurality of coil cores 25—here six coil cores 25—each of which has a longitudinal leg 26 and a transverse leg 27. In the representation in FIG. 1, only three coil cores 25 are visible, the other three coil cores 25 are concealed in the representation by the stator housing 21. Each longitudinal leg 26 extends from a first end 261 in axial direction A to a second end 262, wherein a transverse leg 27 is arranged at the second end 262, which extends in a radial direction R which is perpendicular to the axial direction A. A back iron 28 is arranged at the first end 261, which connects the first ends 261 of all longitudinal legs 26.

The stator further has the cup-shaped recess 211 into which the rotor 3 can be inserted, wherein the cup-shaped recess 211 is arranged at an axial first end 22 of the stator 2. The transverse legs 27 are arranged around the cup-shaped recess 211.

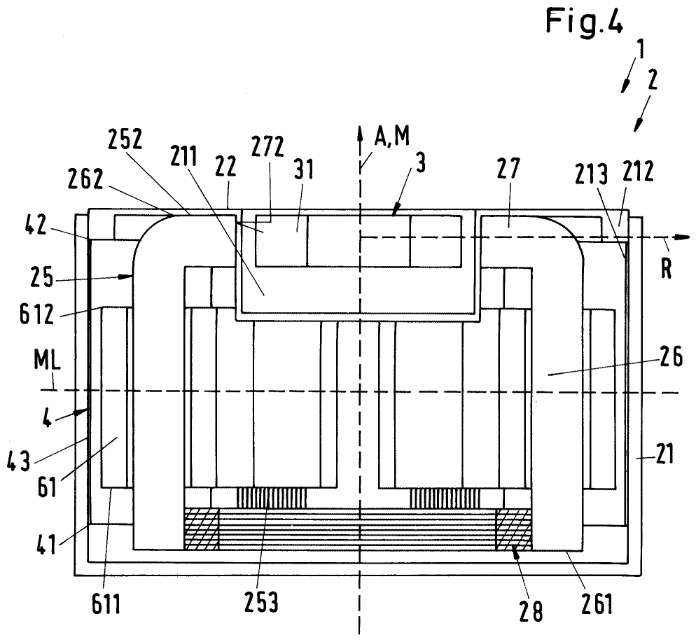

At least one concentrated winding 61 is arranged at each longitudinal leg 26, which surrounds the respective longitudinal leg 26. In the first embodiment, exactly one concentrated winding 61 is provided on each longitudinal leg 26. In other embodiments, more than one concentrated winding can also be arranged at the longitudinal legs 26. For example, there are embodiments (FIG. 4) wherein exactly two concentrated windings 61a, 61b are provided in each case on each of the longitudinal legs 26, each of which surrounds the respective longitudinal leg 26, wherein the two windings 61a, 61b arranged on the same longitudinal leg 26 are arranged adjacent to each other with respect to the axial direction A.

The concentrated windings 61 serve to generate electromagnetic fields with which the rotor 3 can be magnetically levitated without contact in the cup-shaped recess 211.

Furthermore, the stator 2 comprises a shielding 4 which extends in the circumferential direction along a plurality of coil cores 25. The shielding 4 extends in the axial direction A from a first shielding end 41 to a second shielding end 42.

In this embodiment, the shielding 4 is arranged radially outwardly around the coil cores 25 and extends in the circumferential direction over an angle of 280 degrees.

However, embodiments are possible in which the shielding 4 extends over an angle of 360 degrees. However, embodiments are possible in which the shielding 4 extends over more than 360 degrees. Ideally, the shielding 4 extends over an angle of at least 120 degrees, preferably at least 240 degrees.

If the shielding 4 should extend over an angle of 360 degrees, this does not directly mean that it is closed in the circumferential direction. There can also be a distance between a first beginning 46 and a second beginning 47 of the shielding 4. However, it is also possible that the first beginning 46 and the second beginning 47 are in contact or even overlap. In the latter case, an extension of the shielding 4 in the circumferential direction over an angle of more than 360 degrees would be necessary. Embodiments are also possible in which notches are provided in the shielding 4. These notches can be provided, for example, for the feedthrough of connectors through the shielding 4, such as cables.

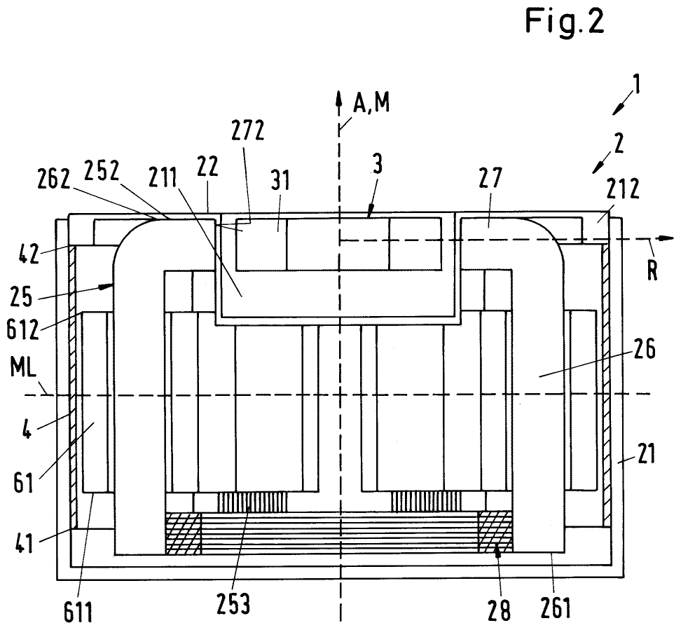

For better understanding, FIG. 2 shows a sectional view along the axial direction A of the first embodiment of the magnetic levitation device from FIG. 1.

In this first embodiment, the shielding 4 is designed in a ring-shaped manner and the first shielding end 41 is arranged below, i.e. closer to the first end 261 of the longitudinal leg 26 in axial direction A than a first winding end 611 of the winding 61.

Here again, the definition applies that “below” with respect to the axial direction A means closer to the first end 261 of the longitudinal leg 26 and “above” with respect to the axial direction A means closer to the second end 262 of the longitudinal leg 26.

In the case where exactly one winding 61 is arranged at the longitudinal leg 26, the first winding end 611 means the end of the winding 61 which is located closer to the first end 261 of the longitudinal leg 26 in the axial direction A. The first winding end 611 can also be regarded as an axially lower winding end 611 if the second winding end 612 is arranged closer to the second end 262 of the longitudinal leg 26 with respect to the axial direction A, and thus represents an axially upper winding end 612.

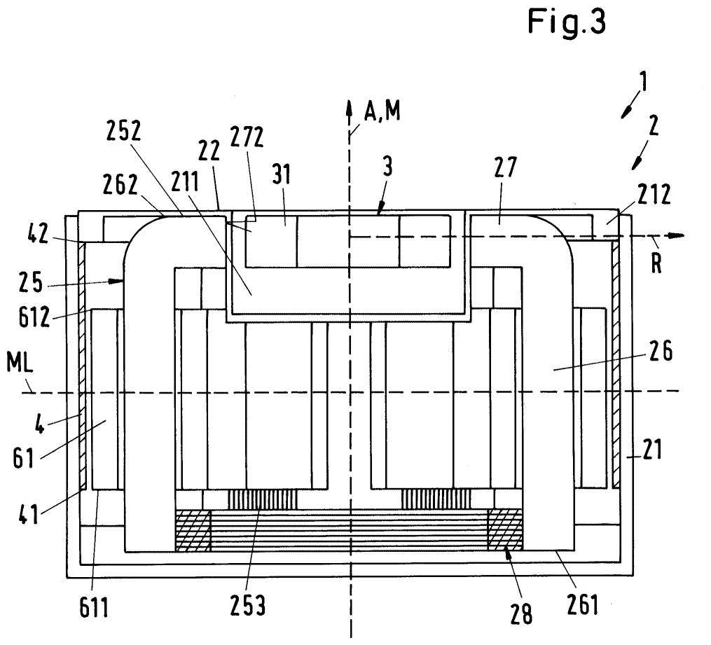

The first shielding end 41 can also be arranged with respect to the axial direction A at the same height as a first winding end 611 (FIG. 3). This arrangement of the shielding 4 can often be sufficient, as the windings 61 are mainly responsible for stray fields because the magnetic fields are generated at the location of the windings. Thus, the shielding 4 ensures an effective shielding of the magnetic fields at that location where they are generated and thus prevents penetration into the stator housing 21. The arrangement of the first shielding end 41 to below the first winding end 611 in the first embodiment can be advantageous for reasons of stability, for example.

However, embodiments are also possible in which the first shielding end 41 is arranged with respect to the axial direction A above the first winding end 611, here preferably between the first winding end 611 and the second winding end 612.

The stray fields are particularly strong especially in the upper area of the stator 2, i.e. in the area that is located closer to the second end 262 of the longitudinal leg 26 in the axial direction. The reason for this is that the iron circuit is not closed there, and the magnetically effective core 31 of the rotor 3 thus only conducts its own magnetic field but not that of the windings 61. On the other hand, in the lower area of the stator 2, i.e. in the area that is located closer to the first end 261 of the longitudinal leg 26 in the axial direction, the magnetic fields are well conducted by the back iron 28 and there are significantly fewer stray fields. Thus, it is advantageous to arrange the shielding 4 at least in the upper area of the stator 2. A smaller extension of the shielding 4 in the axial direction also has the advantage that there is the possibility to build the stator 2 more compactly, which means that less material is required, resulting in lower costs.

In this first embodiment, the shielding 4 extends with respect to the axial direction A to the housing cover 212 of the stator 2, wherein the housing cover 212 is arranged at a first end 22 of the stator 2.

Here, the housing cover 212 is made of plastic, preferably a polypropylene, and the shielding 4 is in contact with the housing cover 212, since the housing cover 212 made of plastic is not conductive. In the case that the housing cover 212 is made of electrically conductive material, there must be a distance between the shielding 4 and the housing cover 212, as otherwise the effect of reducing eddy current losses could be reduced. It is also possible that the shielding 4 has a thin area at its second shielding end 42 over its entire extension in the circumferential direction, which aria extends in the axial direction A, and which is made of an electrically non-conductive material as an insulating layer. It is also possible to achieve such an insulating layer by coating the shielding 4 at the second shielding end 42. In this case, a contact between the shielding 4 and the housing cover 212 is also possible if the shielding 4 is made of electrically conductive material.

A maximum possible extension of the shielding 4 to the housing cover 212 is advantageous because, as already described, most stray fields occur at the axially upper end 22 of the stator 2.

The shielding 4 is preferably made of a highly permeable material. Here, it is preferred that this is a highly permeable material which comprises iron and/or silicon. A highly permeable material is understood to be a material that has a relative permeability μ>40. Further properties of such a preferred material are, inter alia, that it has a low electrical conductivity and low hysteresis losses.

Embodiments are also possible in which the shielding 4 is designed as a sheet metal. The sheet metal can comprise iron and/or silicon. There also exists the possibility of using a mu-metal sheet and/or an electrical sheet metal, preferably a grain-oriented electrical sheet metal for the shielding 4.

In the first embodiment, the coil cores 25 are made of elements 253 in sheet metal, wherein the elements 253 are stacked in the circumferential direction of the stator 2. The circumferential direction refers to that direction which stands perpendicular on the radial direction R and perpendicular on the axial direction A. The elements 253 can be made of an electrical sheet metal, preferably a non-grain-oriented electrical sheet metal. The number of the elements 253 in all embodiments and figures is to be understood as purely exemplary. The number can be larger or smaller than represented.

In the first embodiment, the coil cores 25 further have in each case a rounding off at an axially upper end 252, which redirects the coil core 25 from the axial direction A to the radial direction R.

According to a particularly preferred embodiment, the stator 2 is designed in such a way that, in addition to the contactless magnetic levitation of the rotor 3, it can also exert a torque on the rotor 3 or the magnetically effective core 31 of the rotor 3, which drives the rotor 3 to rotate about the desired axis of rotation. This means that in this preferred embodiment, the rotor 3 can be driven for rotation about the axial direction A by the stator 2.

In this embodiment, the concentrated windings 61 thus generate electromagnetic rotating fields with which the rotor 3 can be both magnetically levitated without contact with respect to the stator 2 and can also be driven without contact for rotation about the axial direction A.

It is understood that the number of six coil cores 25, although preferred, is only to be understood as an example. Of course, such embodiments are also possible in which the stator 2 has fewer than six, e.g. five or four or three coil cores 25, or such embodiments in which the stator 2 has more than six, e.g. seven or eight or nine coil cores 25 or any larger number of coil cores 25.

The rotor 3 comprises the magnetically effective core 31, which is designed in a ring-shaped or disk-shaped manner. According to the representation in FIG. 1, the magnetically effective core 31 is designed as a ring and defines a magnetic center plane. Alternatively, the magnetically effective core 31 can also be designed as a disk. Normally, in the case of a disk-shaped or ring-shaped magnetically effective core 31, the magnetic center plane is the geometric center plane of the magnetically effective core 31 of the rotor 3, which is perpendicular to the axial direction A. In the operating state, the magnetically effective core 31 is levitated in a radial plane, which stands perpendicular on the axial direction A.

The radial plane is indicated in FIG. 1 by the line of a radial direction R, which stands perpendicular on the axial direction A. The radial plane is that plane which stands perpendicular on the axial direction A and contains a radial direction R. The radial plane is that plane in which the magnetically effective core 31 of the rotor 3 is actively magnetically levitated in the operating state. If the rotor 3 is not tilted and is not deflected in the axial direction A, the magnetic center plane lies in the radial plane. The radial plane defines the x-y plane of a Cartesian coordinate system whose z-axis runs in the axial direction A.

The radial position of the magnetically effective core 31 or the rotor 3 refers to the position of the rotor 3 in the radial plane.

Since it is sufficient for the understanding of the disclosure, only the magnetically effective core 31 of the rotor 3 is represented in the drawing in FIG. 1 and in FIG. 2. It is understood that the rotor 3 can of course also comprise further components such as jackets or encapsulations of the magnetically effective core 31, which are preferably made of a plastic, or of a metal or of a metal alloy or of a ceramic or a ceramic material. Furthermore, the rotor 3 can also comprise vanes for mixing, stirring or pumping fluids or other components.

When the rotor 3 is inserted into the cup-shaped recess 211, the rotor 3 and in particular the magnetically effective core 31 of the rotor 3 is surrounded by the radially outwardly arranged end faces 272 of the transverse legs 27 of the coil cores 25 of the stator 2. Thus, the transverse legs 27 form a plurality of pronounced stator poles-in this case six stator poles.

When the magnetically effective core 31 of the rotor 3 is in its desired position during operation, the magnetically effective core 31 is centered between the end faces 272 of the transverse legs 27. According to the representation, the concentrated windings 61 are arranged below the radial plane E and are aligned such that their coil axes extend in the axial direction A.

All first ends 261 of the longitudinal legs 26—i.e., the lower ends 261 according to the representation (FIG. 1)—are connected to each other by a back iron 28. The back iron 28 is preferably designed in a ring-shaped manner. Such embodiments are possible (see FIG. 1, for example) in which the back iron 28 extends radially inwardly along all first ends 261 of the longitudinal legs 26.

In order to generate the electromagnetic fields required for the magnetic levitation of the rotor 3 and optionally for the generation of a torque on the rotor 3, the longitudinal legs 26 of the coil cores 25 carry the windings designed as concentrated windings 61.

In the operating state, those electromagnetic rotating fields are generated with these concentrated windings 61 with which an arbitrarily adjustable transverse force in the radial direction can be exerted on the rotor 3, so that the radial position of the rotor 3, i.e. its position in the radial plane perpendicular to the axial direction A, can be actively controlled or regulated. Optionally, a torque is additionally effected on the rotor 3 with these electromagnetic rotating fields.

The “magnetically effective core 31” of the rotor 3 refers to that region of the rotor 3 which magnetically cooperates with the stator 2 for the generation of the magnetic levitation forces and optionally for torque generation.

As already mentioned, the magnetically effective core 31 is designed in a ring-shaped manner in this embodiment. Furthermore, the magnetically effective core 31 is designed in a permanent magnetic manner. For this purpose, the magnetically effective core 31 can comprise at least one permanent magnet, but also several permanent magnets, or—as in the embodiment described here—consist entirely of a permanent magnetic material, so that the magnetically effective core 31 is the permanent magnet. For example, the magnetically effective core 31 is magnetized in the radial direction.

Those ferromagnetic or ferrimagnetic materials, which are magnetically hard, that is which have a high coercive field strength, are typically called permanent magnets. The coercive field strength is that magnetic field strength which is required to demagnetize a material. Within the framework of this application, a permanent magnet is understood as a component or a material, which has a coercive field strength, more precisely a coercive field strength of the magnetic polarization, which amounts to more than 10′000 A/m.

Such embodiments are also possible in which the magnetically effective core 31 is designed in a permanent magnet-free manner, i.e., without permanent magnets. The rotor 3 is then designed, for example, as a reluctance rotor. Then, the magnetically effective core 31 of the rotor 3 is made of a soft magnetic material, for example. Suitable soft magnetic materials for the magnetically effective core 31 are, for example, ferromagnetic or ferrimagnetic materials, i.e., in particular iron, nickel-iron, cobalt-iron, silicon iron, mu-metal.

Furthermore, embodiments are possible in which the magnetically effective core 31 of the rotor 3 comprises both ferromagnetic materials and permanent magnetic materials. For example, permanent magnets can be placed or inserted into a ferromagnetic base body. Such embodiments are advantageous, for example, if one wishes to reduce the costs of large rotors by saving permanent magnetic material.

Embodiments are also possible in which the rotor is designed according to the principle of a cage rotor.

The ring-shaped back iron 28 can be made of a soft magnetic material because it serves as flux conducting element to conduct the magnetic flux.

Suitable soft magnetic materials for the back iron 28 are, for example, ferromagnetic or ferrimagnetic materials, i.e., in particular iron, nickel-iron, cobalt-iron, silicon-iron or mu-metal. In this case, for the stator 2, a design as a stator sheet metal stack is preferred, in which the back iron 28 is designed in sheet metal, i.e., it includes several thin sheet metal elements, which are stacked parallel to each other in the axial direction A. All elements are identically designed, i.e., in this case substantially ring-shaped and also with the same thickness in each case. Thus, the back iron 28 itself is substantially designed in a ring-shaped manner and extends radially inwardly along the first ends 261 of the longitudinal legs 26 in the assembled state.

Furthermore, it is possible that the back iron 28 consists of pressed and subsequently sintered grains of the aforementioned materials. The metallic grains are preferably embedded in a plastic matrix so that they are at least partially insulated from each other, whereby eddy current losses can be minimized. Thus, soft magnetic composites, which consist of electrically insulated and compressed metal particles are also suitable for the stator 2. In particular, these soft magnetic composites, which are also designated as SMC (Soft Magnetic Composites), can include iron powder particles which are coated with an electrically insulating layer. These SMC are then formed into the desired shape by powder metallurgy processes.

Embodiments are also conceivable in which a so-called tape wound toroidal core is used as the back iron 28. This is a coiled strip made of electrical sheet metal. Preferably, grain-oriented electrical sheet metal is used here. In the state of the art, tape wound toroidal cores are known mainly for the use for transformers, transmitters, inductors but not for bearing devices and particularly not for electromagnetic rotary drives.

During operation of the magnetic levitation device 1, the magnetically effective core 31 of the rotor 3 cooperates with the stator 2 in such a way that the rotor 3 can be magnetically levitated without contact with respect to the stator 2 and preferably can also be magnetically set in rotation without contact about the axial direction A. In this case, it is particularly advantageous that the same windings 61, with which the magnetic levitation of the rotor 3 is effected, also serve to generate a torque on the rotor 3. Preferably, three degrees of freedom of the rotor 3 can then be actively regulated, namely its position in the radial plane and its rotation. With respect to its axial deflection from the radial plane in the axial direction A, the magnetically effective core 31 of the rotor 3 is passively magnetically stabilized by reluctance forces, i.e., it cannot be controlled. The magnetically effective core 31 of the rotor 3 is also passively magnetically stabilized with respect to the remaining two degrees of freedom, namely tilting with respect to the radial plane perpendicular to the desired axis of rotation. By the cooperation of the magnetically effective core 31 with the coil cores 25, the rotor 3 is thus passively magnetically levitated or passively magnetically stabilized in the axial direction A and against tilting (a total of three degrees of freedom) and actively magnetically levitated in the radial plane (two degrees of freedom).

As is generally the case, an active magnetic levitation is also referred to in the framework of this application as one which can be actively controlled or regulated, for example by the electromagnetic fields generated by the concentrated windings 61. A passive magnetic levitation or a passive magnetic stabilization is one that cannot be controlled or regulated. The passive magnetic levitation or stabilization is based, for example, on reluctance forces, which bring the rotor 3 back again to its desired position when it is deflected from its desired position, i.e., for example, when it is displaced or deflected in the axial direction A or when it is tilted.

In the magnetic levitation device 1, in contrast to classic magnetic bearings, the magnetic levitation—and optionally the generation of a torque acting on the rotor—is realized by electromagnetic rotating fields. For the combined generation of the magnetic levitation forces and a torque for rotating the rotor 3 about the axial direction A, it is possible on the one hand—as shown in FIG. 1—to arrange exactly one concentrated winding 61 at each longitudinal leg 26.

On the other hand, embodiments are also possible in which two different winding systems are provided for the combined generation of the magnetic levitation forces and a torque for rotating the rotor 3. For this purpose, for example, exactly two concentrated windings 61a, 61b are arranged in each case at each longitudinal leg 26 (see, e.g., FIG. 4), which are arranged adjacent to each other with respect to the axial direction A. One of these two windings 61a, 61b belongs to the first of the two winding systems and the other to the second of the two winding systems.

In the embodiment represented in FIG. 1 with exactly one concentrated winding 61 at each coil core 25, for example the values for the current required for the levitation and the current required for the generation of the torque determined in each case in a control unit are added or superimposed by calculation—e.g., with the aid of software. Then, the resulting total current is impressed into the respective concentrated winding 61.

If the stator 2 of the magnetic levitation device 1 according to the disclosure is designed for generating a torque, the magnetic levitation device 1 is suitable for an electromagnetic rotary drive, which is designed as a temple motor. It is also possible that the magnetic levitation device 1 according to the disclosure is also suitable for other devices, such as centrifugal pumps, mixing devices for mixing flowable substances, stirring devices, for example for mixing a fluid in a tank, fans or also for devices for supporting and rotating wafers, for example in the semiconductor production.

FIG. 3 shows a sectional view of a second embodiment of a magnetic levitation device 1 according to the disclosure. The section is carried out along the axial direction A. In the following description of the second embodiment, only the differences to the first embodiment from FIG. 1 are explained in more detail. The explanations to the first embodiment also apply in the same way or analogously to the second embodiment. The same reference signs designate the same features that were explained with reference to the first embodiment or features equivalent in function.

In the second embodiment, one difference is that the first shielding end 41 is arranged at the same height with respect to the axial direction A as the first winding end 611. The advantages of this have already been explained.

FIG. 4 shows a sectional view of a third embodiment of a magnetic levitation device 1 according to the disclosure. The section is carried out along the axial direction A. In the following description of the third embodiment, only the differences to the preceding embodiments are explained in more detail. The explanations to the preceding embodiments also apply in the same way or analogously to the third embodiment. The same reference signs designate the same features that were explained with reference to the preceding embodiments or features equivalent in function.

In this embodiment, one difference is that the shielding 4 is designed as a coating 43, which is preferably applied to a radially inside located side 213 of the stator housing 21. The coating 43 has the advantage that it can be applied to the already existing stator housing 21 by the usual coating methods known from the state of the art (e.g. PVD method, thermal spraying). In doing so, no additional material (such as electrical sheet metal) is required for the shielding 4 and the shielding 4 can already be applied during the production of the stator housing 21, which saves an additional work step. Preferably, the coating 43 comprises iron and/or plastic-bonded metal particles. Preferably, the coating thickness is greater than 50 micrometers.

The coating 43 can extend over the entire radially inside located side 213 of the stator housing 21 in the axial direction A, or over only a fraction of the extension of the radially inside located side 213 in the axial direction A. It is possible, for example, that the coating 43 is only applied to the radially inside located side 213 of the stator housing 21 in the area between the first winding end 611 and the second winding end 612. Preferably, the coating 43 extends over the entire circumference of the radially inside located side 213 of the stator housing 21.

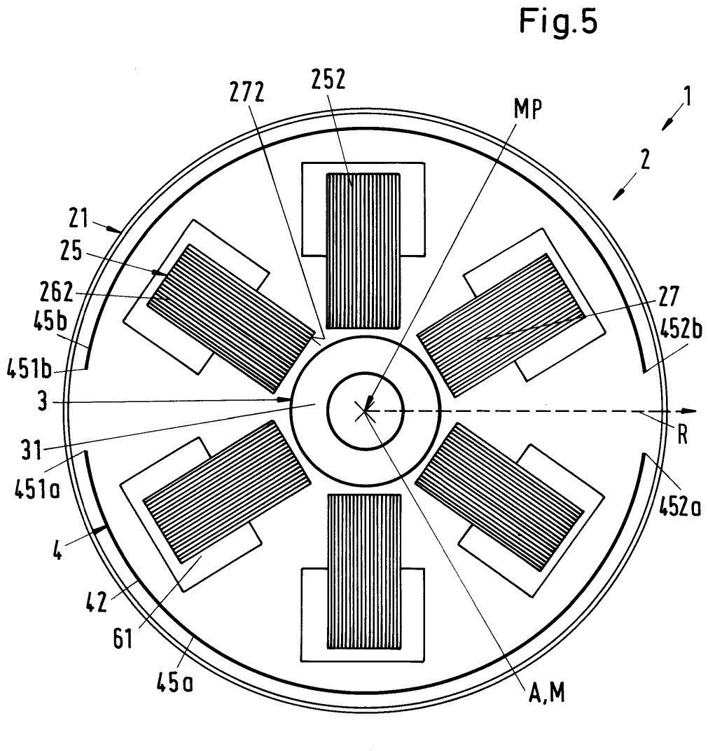

FIG. 5 shows a sectional view of a fourth embodiment of a magnetic levitation device 1 according to the disclosure. In this case, the section is carried out in the radial plane. In the following description of the fourth embodiment, only the differences to the preceding embodiments are explained in more detail. The explanations to the preceding embodiments also apply in the same way or analogously to the fourth embodiment. The same reference signs designate the same features that were explained with reference to the preceding embodiments or features equivalent in function.

In this embodiment, one difference is that the shielding 4 comprises two shielding segments 45a, 45b, each of which extends from a first segment end 451a, 451b in the circumferential direction to a second segment end 452a, 452b. Here, the number of the shielding segments 45a, 45b is to be understood as purely exemplary. The shielding 4 comprises at least two shielding segments 45a, 45b, but can also comprise more than two, for example three, four, five or even more shielding segments 45.

It is possible that the shielding segments 45a, 45b are made of different materials.

In this embodiment, the shielding segments 45a, 45b are arranged adjacent to each other in the circumferential direction and have a distance to each other, i.e. the first and second segment ends 451a, 451b, 452a, 452b are not in contact with each other in this embodiment. However, it is also possible that all or only a part of the segment ends 451a, 451b, 452a, 452b are in contact with one another or that the shielding segments 45a, 45b overlap.

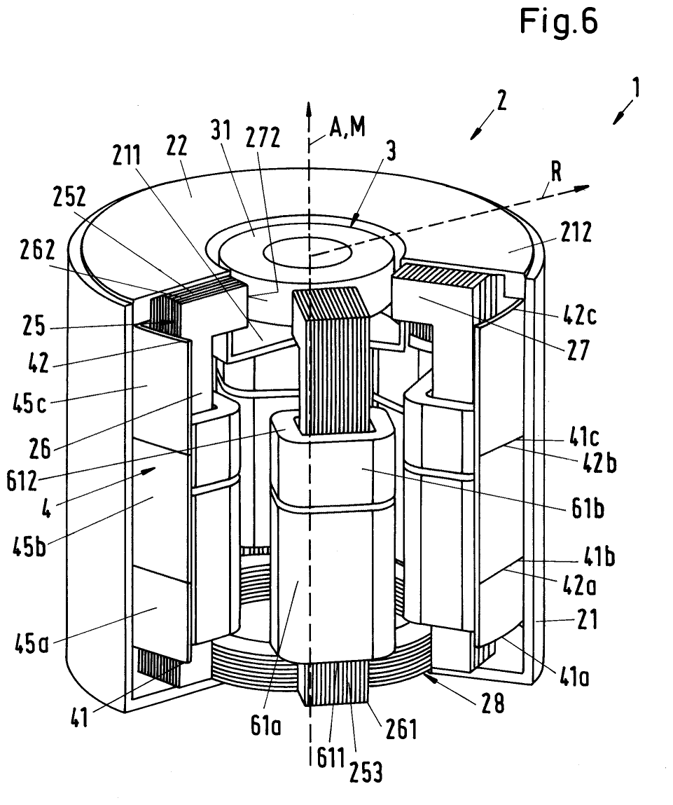

Embodiments are also possible in which the shielding segments 45a, 45b are arranged adjacent to each other in the axial direction A. Such an embodiment is illustrated in FIG. 6.

FIG. 6 shows a perspective view of a fifth embodiment of a magnetic levitation device 1 according to the disclosure, wherein a part of the stator housing 21 is removed. In the following description of the fifth embodiment, only the differences to the preceding embodiments are explained in more detail. The explanations to the preceding embodiments also apply in the same way or analogously to the fifth embodiment. The same reference signs designate the same features that were explained with reference to the preceding embodiments or features equivalent in function.

One difference to the preceding embodiments is that in this embodiment, the shielding 4 comprises several—here three—shielding segments 45a, 45b, 45c, which are arranged adjacent to one another with respect to the axial direction A. The number of shielding segments 45a, 45b, 45c is to be understood as purely exemplary. In this embodiment, the extension of the individual shielding segments 45a, 45b, 45c is different compared to one another. In other words, the width of the individual shielding segments 45a, 45b, 45c in the axial direction A is different. However, embodiments are also possible in which the shielding segments 45a, 45b, 45c have the same width in the axial direction A. In this embodiment, the three shielding segments 45a, 45b, 45c all have the same shape. However, it is also possible that in other embodiments the individual shielding segments 45a, 45b, 45c are designed differently with regard to their shape. Here, it should be noted that the shielding segments 45a, 45b, 45c are designed in such a way that they can be arranged adjacent to one another at a respective first axial segment end 41a, 41b, 41c with the corresponding respective second axial segment end 42a, 42b, 42c.

A second difference is that the coil cores 25 have no rounding off at the axially upper end 252. A further difference is that exactly two concentrated windings 61a, 61b are provided here on each longitudinal leg 26, each of which surrounds the respective longitudinal leg 26, and which are arranged adjacent to each other with respect to the axial direction A. In this case, that more than one winding 61a, 61b is arranged at the respective longitudinal leg 26, the first winding end 611 is the first winding end 611 of that winding 61a which is arranged closer to the first end 261 of the longitudinal leg 26 in the axial direction A. In other words, the first winding end 611 is the axially lower end of the axially lowermost winding 61a arranged at the longitudinal leg 26. Here again, the definition applies that “lower” means closer to the first end 261 of the longitudinal leg 26 and “upper” means closer to the second end 262 of the longitudinal leg 26.

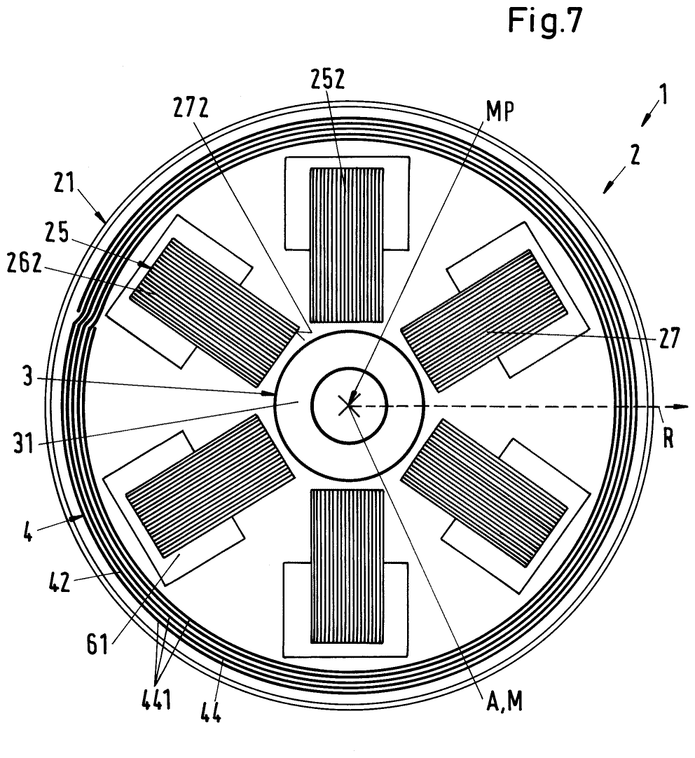

FIG. 7 shows a sectional view of a sixth embodiment of a magnetic levitation device 1 according to the disclosure. In this case, the section is carried out in the radial plane. In the following description of the sixth embodiment, only the differences to the preceding embodiments are explained in more detail. The explanations to the preceding embodiments also apply in the same way or analogously to the sixth embodiment. The same reference signs designate the same features that were explained with reference to preceding embodiments or features equivalent in function.

Here, one difference is that the shielding is designed as a strip 44, wherein the strip 44 forms several strip windings 441 which lie flat against one another with respect to the radial direction R. It is particularly preferred that the several strip windings 441 are insulated from one another.

Here, the strip 44 can be made of an electrical sheet metal, preferably a grain-oriented electrical sheet metal. According to the general definition, an electrical sheet metal is understood to be a soft magnetic material for magnetic cores. There also exists the possibility of using mu-metal for the strip 44.

Here, the advantage is that such strips 44 are frequently used in technology and are therefore cost-effective. It is also advantageous that a strip 44 can be produced relatively easily and that it is possible to insulate the strip windings 441 from one another directly during production.

Needless to say, that all embodiments with their respective characteristics shown in the descriptions of the figures can be combined with each other in any way.

Furthermore, it is possible that all of the embodiments shown can be designed with coil cores 25 which are designed in such a way that the space available for the rotor 3 in the magnetic levitation device 1 is increased. This is achieved by a special external shape of the coil cores 25.

In the process, the coil core 25 is divided into an axially lower section and an axially upper section, wherein the lower section and the upper section are arranged adjacent to each other with respect to the axial direction A. The transverse leg 27 is arranged at the axially upper section. For each coil core 25, the end face 272 of the transverse leg 27 has a first distance in the radial direction from the axially lower section of the associated longitudinal leg 26, and a second distance in the radial direction from the axially upper section, wherein the second distance is greater than the first distance. This means that each longitudinal leg 26 is designed in such a way that the axially upper section is displaced outwards in the radial direction with respect to the axially lower section, so that the space available for the rotor 3 between the end faces 272 is increased without the risk of a direct transfer of the magnetic flux between the longitudinal leg 26 and the magnetically effective core 31 of the rotor 3 existing. Due to the fact that the axially upper sections are offset radially outwards with respect to the radial direction and relative to the axially lower sections, the distance, namely the second distance, between the longitudinal legs 26 and the end faces 272 increases in the area of the axially upper sections. In doing so, the distance between the magnetically effective core 31 of the rotor and the longitudinal legs 26, particularly in the area of the axially upper sections, also increases.

Such coil cores 25 just described are designed analogously to those coil cores illustrated in FIG. 3 in the European patent application EP4084304A1.

What is claimed is:

1. A magnetic levitation device for contactless magnetic levitation of a rotor including a disk-shaped or ring-shaped magnetically effective core, the magnetic levitation device comprising:
a stator with a stator housing, the stator comprising a plurality of coil cores, each of the plurality of coils comprising a longitudinal leg extending from a first end in an axial direction to a second end, and a transverse leg arranged at the second end of the longitudinal leg, the transverse leg extending in a radial direction perpendicular to the axial direction, a back iron arranged at the first end of each of the plurality of coil cords so as to connect the first ends of the longitudinal legs of the plurality of coil cords, at least one concentrated winding disposed on the longitudinal leg of each of the plurality of coil cords, and surrounding the longitudinal leg, the stator further has a cup-shaped recess into which the rotor is capable of being inserted, the cup-shaped recess arranged at an axial end of the stator, and the transverse legs of the plurality of coil cord arranged around the cup-shaped recess,
the stator comprising a shielding extending in a circumferential direction along the plurality of coil cores, and in the axial direction from a first shielding end to a second shielding end.

2. The magnetic levitation device according to claim 1, wherein the shielding is arranged radially outwardly around the plurality of coil cores and extends in the circumferential direction over an angle of at least 120 degrees.

3. The magnetic levitation device according to claim 1, wherein the shielding is configured in a ring-shaped manner.

4. The magnetic levitation device according to claim 1, wherein the shielding comprises at least two shielding segments, each of the at least two shielding segments extending from a first segment end in the circumferential direction to a second segment end.

5. The magnetic levitation device according to claim 4, wherein the at least two shielding segments are arranged adjacent to each other in the circumferential direction.

6. The magnetic levitation device according to claim 1, wherein the shielding is a strip forming several strip windings lying flat against one another with respect to the radial direction.

7. The magnetic levitation device according to claim 1, wherein the first shielding end is arranged with respect to the axial direction at a same height as a first winding end.

8. The magnetic levitation device according to claim 1, wherein the first shielding end is arranged with respect to the axial direction above a first winding end.

9. The magnetic levitation device according to claim 1, wherein the shielding extends with respect to the axial direction to a housing cover of the stator, the housing cover arranged at a first end of the stator.

10. The magnetic levitation device according to claim 1, wherein the shielding is made of a highly permeable material.

11. The magnetic levitation device according to claim 1, wherein the shielding is a coating.

12. The magnetic levitation device according to claim 1, wherein the shielding is a sheet metal.

13. The magnetic levitation device according to claim 1, wherein the at least one concentrated winding includes two concentrated disposed on each longitudinal leg, each of the two concentrated windings surrounding the longitudinal leg, and being arranged adjacent to each other with respect to the axial direction.

14. The magnetic levitation device according to claim 1, wherein the stator is configured to generate a torque with which the rotor is capable of being magnetically driven without contact for rotation about the axial direction.

15. An electromagnetic rotary drive, which is a temple motor, the electromagnetic rotary drive comprising:
the magnetic levitation device according to claim 14; and
the rotor with the disk-shaped or ring-shaped magnetically effective core, the rotor insertable into the cup-shaped recess, and the rotor is the rotor of the electromagnetic rotary drive.

16. The magnetic levitation device according to claim 1, wherein the shielding is arranged radially outwardly around the plurality of coil cores and extends in the circumferential direction over an angle of at least 240 degrees.

17. The magnetic levitation device according to claim 1, wherein the shielding is made of a highly permeable material comprising iron and silicon.

18. The magnetic levitation device according to claim 1, wherein the shielding is a coating applied to a radially inside side of the stator housing.
